(19) United States
(12) Patent Application Publication
(10) Pub. No.: US 2009/0027712 A1
(43) Pub. Date: Jan. 29, 2009

(54) IMAGE FORMING APPARATUS, IMAGE PROCESSING APPARATUS, AND IMAGE PROCESSING METHOD

(76) Inventor: Masaki SONE, Osaka (JP)

Correspondence Address: OSTROLENK FABER GERB & SOFFEN, 1180 AVENUE OF THE AMERICAS, NEW YORK, NY, 100368403, US

(21) Appl. No.: 12/179,685

(22) Filed: Jul. 25, 2008

(30) Foreign Application Priority Data
Jul. 27, 2007 (JP) P2007-195941

(51) Int. Cl. G06K 15/02

(52) U.S. Cl. 358/1.13

(57) ABSTRACT

An image forming apparatus includes: a display unit; an operation unit; a printing unit; a storage unit which stores print data of the printing target image; a control unit which generally controls the display unit, the operation unit, the printing unit, and the storage unit. When the operation unit accepts an instruction to display a preview image, the control unit: controls the display unit to display the preview image for a user to verify the content of the printing target image, on the basis of the print data stored in the storage unit; classifies the whole area of the preview image into a text area and a picture area; and controls the display unit to display an image of the text area prior to an image of the picture area, and then to display the image of the picture area.

### BACKGROUND OF THE INVENTION

1. Field of the Invention

Priority is claimed on Japanese Patent Application No. 2007-195941, filed Jul. 27, 2007, the contents of which are incorporated herein by reference.

The present invention relates to an image forming apparatus, an image processing apparatus, and an image processing method.

2. Description of Related Art

A conventional image forming apparatus is provided with a storage device such as a hard disk capable of preserving print data. As such an image forming apparatus, an image forming apparatus having a function of displaying a preview image is disclosed in Japanese Unexamined Patent Application, First Publication No. 2006-41947. In the image forming apparatus, a print data is selected from data stored in a storage device, a preview image of the print data is generated as needed and displayed for confirmation, and then a printing process of the print data can be performed, through an operation display unit of the image forming apparatus.

The conventional image forming apparatus described above is embodied, for example, as a multifunctional printer.

There are many cases where a multifunctional printer is used by a plurality of users. For this reason, while one user is selecting print data stored in a storage device and performing an operation to display a preview image, there are many cases where other jobs from other users are cued through an intranet. In this case, there is a problem in that delay occurs until the preview image is displayed.

In displaying a preview image, a particularly long time is needed for print data having a large file size. The file size of the print data tends be larger when an image is included therein, when compared to cases where only text information is included.

In consideration of such circumstances, an object of the present invention is to provide an image forming apparatus having superior usability for a user, when displaying an image such as a preview image on a display unit.

### SUMMARY OF THE INVENTION

In order to achieve the object, the present invention employs the following.

(1) An image forming apparatus including: a display unit which displays various kinds of information; an operation unit which accepts an operation from a user; a printing unit which prints a printing target image on a recording medium; a storage unit which stores print data of the printing target image; and a control unit which integrally controls the display unit, the operation unit, the printing unit, and the storage unit, wherein, when the operation unit accepts an instruction to display a preview image, the control unit: generates the preview image from the print data stored in the storage unit, for the user to verify the content of the printing target image; divides the whole area of the preview image into a text area and a picture area; and controls the display unit to display an image of the text area, and then to display an image of the picture area.

(2) In the image forming apparatus, it may be arranged such that: the control unit performs a stepwise display in which a low-resolution image is displayed and then a high-resolution image is displayed, when displaying the image of the picture area.

(3) In the image forming apparatus, it may be arranged such that: the control unit performs the stepwise display, when a number of intermediate gradation dots in the picture area is greater than a predetermined threshold value.

(4) In the image forming apparatus, it may be arranged such that: the control unit determines that, in the whole area of the preview image: a first area is the text area, when the first area includes sub-areas having incontinuous gradations, disposed next to each other; and a second area is the picture area, when gradations in the second area are continuously changed.

(5) In the image forming apparatus, it may be arranged such that: the operation unit accepts the instruction to display the preview image, and then accepts an instruction to cancel displaying the preview image, during a displaying process of the preview image.

Furthermore, in order to achieve the object, the present invention employs the following.

(6) An image processing apparatus including: a display unit which displays various kinds of information; an operation unit which accepts an operation from a user; a storage unit which stores target data of a target image; and a control unit which integrally controls the display unit, the operation unit, and the storage unit, wherein when the operation unit accepts an instruction to display a preview image, the control unit: generates a preview image from the target data stored in the storage unit, for the user to verify the content of the target image; divides the whole area of the preview image into a text area and a picture area; and controls the display unit to display an image of the text area, and then to display an image of the picture area.

Furthermore, in order to achieve the object, the present invention employs the following.

(7) An image processing method in which a user verifies the content of a target image, including the steps of: generating a preview image from the target image stored in a storage unit; dividing the whole area of the preview image into a text area and a picture area; displaying an image of the text area; and after displaying the image of the text area, displaying an image of the picture area.

According to the invention, the text area is displayed prior to the picture area, at the time of displaying the preview image.

In displaying the preview image in the image forming apparatus, a particularly important part for a user is a part including information for determining whether or not the print data is data to be printed. In many cases, the part to which the user pays attention at the time of this determination is mainly a text area rather than a picture area. In addition, since the text area has a small data size, only a small amount of time is necessary for the display process.

According to the invention, an important part for a user is displayed with priority, when displaying an image such as the preview image in the image forming apparatus. For this reason, a superior usability for the user can be achieved.

### BRIEF DESCRIPTION OF THE DRAWINGS

FIG. 1 is a block diagram illustrating a functional configuration of a multifunctional printer according to an embodiment of the present invention.

FIG. 2 is a diagram illustrating an example of a preview image according to the embodiment.

FIG. 3 is a flowchart illustrating the operations of the main parts of the multifunctional printer according to the embodiment.

FIG. 4A is a diagram illustrating a display example of an operation display unit in Step S3 or S6 shown in FIG. 3.

FIG. 4B is a diagram illustrating a display example of an operation display unit in Step S4 shown in FIG. 3.

FIG. 4C is a diagram illustrating a display example of an operation display unit in Step S5 shown in FIG. 3.

### DETAILED DESCRIPTION OF THE INVENTION

Hereinafter, an embodiment of the present invention will be described with reference to the drawings.

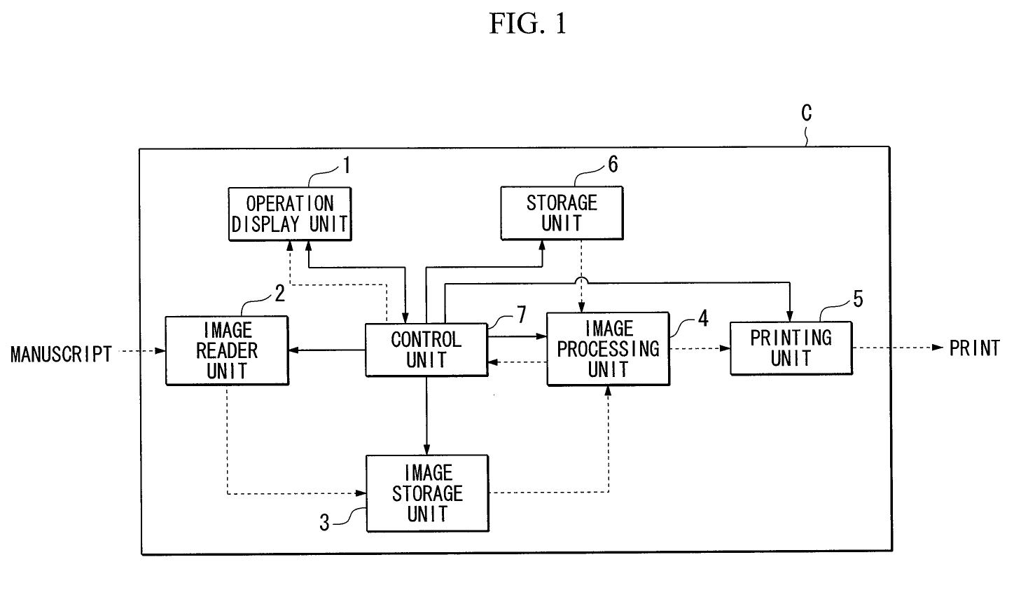

FIG. 1 is a block diagram illustrating a functional configuration of a multifunctional printer C according to an embodiment of the present invention. As shown in FIG. 1, the multifunctional printer C (image forming apparatus) includes an operation display unit 1, an image reader unit 2, an image storage unit 3, an image processing unit 4, a printing unit 5, a storage unit 6, and a control unit 7.

The operation display unit 1 (display unit, operation unit) has a touch panel and operation keys, and serves as a man-machine interface correlating a user and the multifunctional printer C.

As previously known, the touch panel may have a transparent press sensor, such as a resistive-film type sensor, on the displaying-side surface of the display panel.

The display panel displays a plurality of operation buttons, to which various kinds of functions are assigned, in a predetermined layout under the control of the control unit 7.

The sheet press sensor outputs an operation signal indicating a pressed position (a coordination of the pressed position) to the control unit 7, when a user presses down an operation button with a finger or the like.

The operation keys (hardware keys) are keys other than the operation buttons displayed on the touch panel. The operation keys, for example, include a power key, a copy start key, a clear key, and the like.

The operation buttons displayed on the touch panel are displayed on the display panel by executing a predetermined program by the control unit 7. On the other hand, the operation keys are physically disposed as hardware keys. The operation buttons and the operation keys output operation signals based on operations of a user to the control unit 7.

In addition, as one of the operation buttons, there is a preview button. For example, when data (described later) stored in the storage unit 6 is displayed in a list, the preview button is also displayed. When the preview button is pressed down, the operation display unit 1 receives an instruction from a user to display a preview image on the display panel of the touch panel, that is, a preview instruction. The operation display unit 1 outputs a signal representing a reception of the preview instruction, to the control unit 7.

The image reader unit 2 reads an image (manuscript image) of a manuscript either automatically fed by an ADF (Auto Document Feeder) or placed on a platen glass, by a line sensor, following control instructions input from the control unit 7, and creates image data (manuscript image data). The manuscript image data is output to the storage unit 3.

The image storage unit 3 (storage unit), which is a semiconductor memory, a hard disk device, or the like, stores the manuscript image data following the control instruction input from the control unit 7, reads out the manuscript image data, and outputs the data to the image processing unit 4.

The image processing unit 4 performs various kinds of processes on the manuscript image data as needed, following the control instruction input from the control unit 7. The image processing unit 4 transforms the manuscript image data into another image data (i.e., print data) suitable for the printing method of the printing unit 5, and outputs the data to the printing unit 5. The image processes include image processes corresponding to enlargement and reduction printing.

When the image reader unit 2 reads a color manuscript, the manuscript image data input from the image storage unit 3 to the image processing unit 4 is an RGB image data (color image data) corresponding to three primary colors of light. The image processing unit 4 transforms such an RGB image data, for example, into print data based on YMCK image data, that is, Y (yellow), M (magenta), C (cyan), and K (black), and outputs the data to the printing unit 5.

The printing unit 5 prints an image based on the print data (i.e., printing target data) input from the image processing unit 4 on a paper fed from a paper cassette, following the control instruction input from the control unit 7. The printing unit 5 is, for example, a tandem-type printing device in which four development devices corresponding to toners of the basic colors are arranged on a secondary transfer belt. The printing unit 5 prints a printing target image in colors on a paper, on the basis of the YMCK print data input from the image processing unit 4.

The storage unit 6, which is a hard disk or the like, stores the print data of a user via an intranet (not shown). The user selects the print data stored in the storage unit 6 by an instruction to the operation display unit 1, instructs the operation display unit 1 to display a preview image as necessary, and instructs the printing unit 5 to perform a printing process.

The control unit 7 includes an MPU (Micro Processing Unit), an internal memory, and an interface circuit that transmits and receives various kinds of signals to and from the operation display unit 1, the image reader unit 2, the image storage unit 3, the image processing unit 4, and the printing unit 5. The control unit 7 controls the entire operations of the multifunctional printer C, on the basis of a control program previously stored in the internal memory and operation instructions input from the operation display unit 1. The control unit 7 and the operation display unit 1 transmit and receive various kinds of signals in a predetermined communication protocol, and thus the control unit 7 recognizes and controls an operation state of the operation display unit 1.

When a signal representing reception of a preview instruction from a user is input from the operation display unit 1, the control unit 7 acquires print data from the storage unit 6 or the image processing unit 4. Then, the control unit 7 creates a preview image data on the basis of the print data, and controls the operation display unit 1 to display a preview image on the basis of the preview image data.

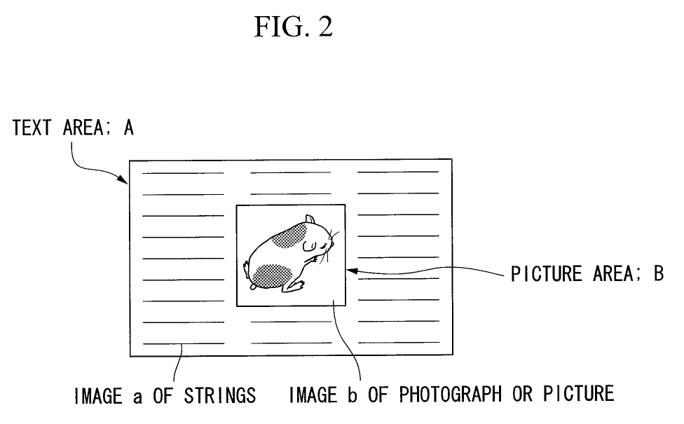

In the present embodiment, the control unit 7 divides the whole area of the preview image into a text area A and a picture area B, at the time of displaying the preview image, as shown in FIG. 2. The control unit 7 displays the text area A prior to the picture area B, and then displays the picture area B. The text area A is an area occupied by image (a) of text strings in the preview image. The picture area B is an area occupied by image (b) of photographs or pictures in the preview image. In this case, the detailed operation of the control unit 7 is as follows.

The control unit 7 analyzes the preview image data, that is: divides the preview image which is configured on the basis of the preview image data, into a plurality of small areas; determines whether or not each of the small areas satisfies any of the following conditions; and thereby characterizes each of the small areas.

(1) Pixels having binary-patterned intensities continuously occur.

(2) The image in the area matches any of predetermined patterns (characters, signs, or the like.)

(3) The number (line number per one inch) of screen lines matches a predetermined value (e.g., 85 lines, 133 lines).

(4) Intensity of the pixels change continuously and gradually.

Subsequently, the control unit 7 determines that a small area satisfying the condition (1) or (2) is a text area, and determines that a small area satisfying the condition (3) or (4) is a picture area.

Hereinafter, one example of the determination method for defining the small areas of the preview image will be described. The control unit 7 performs the following determinations on all pixels included in each small area. First, the control unit 7 compares the intensity of any pixel with the intensity adjacent to the pixel. When the difference in intensity is equal to a predetermined value or greater, the pixel is determined as a discontinuous pixel.

When the proportion of the number of discontinuous pixels among all pixels in the small area is equal to or higher than a predetermined proportion, the control unit 7 determines that this small area is a text area.

In addition to the determination, or instead of the determination, the control unit 7 may perform the following determination. That is, the control unit 7 may make a histogram of intensity distribution with about all pixels included in each small area. The control unit 7 performs peak analysis of the histogram to extract two or more peak intensities. The control unit 7 calculates the number of pixels having a intensity included in a predetermined range, measured from these peak intensities. When the ratio of the number of pixels satisfying this condition to the total number of pixels of the small area is equal to or greater than a predetermined value, the small area is determined as a text area.

When small areas adjacent to each other are text areas or picture areas, the control unit 7 integrates them together.

The control unit 7 repeats the above-described processes, thereby dividing the whole preview image configured on the basis of the preview image data into a text area and a picture area.

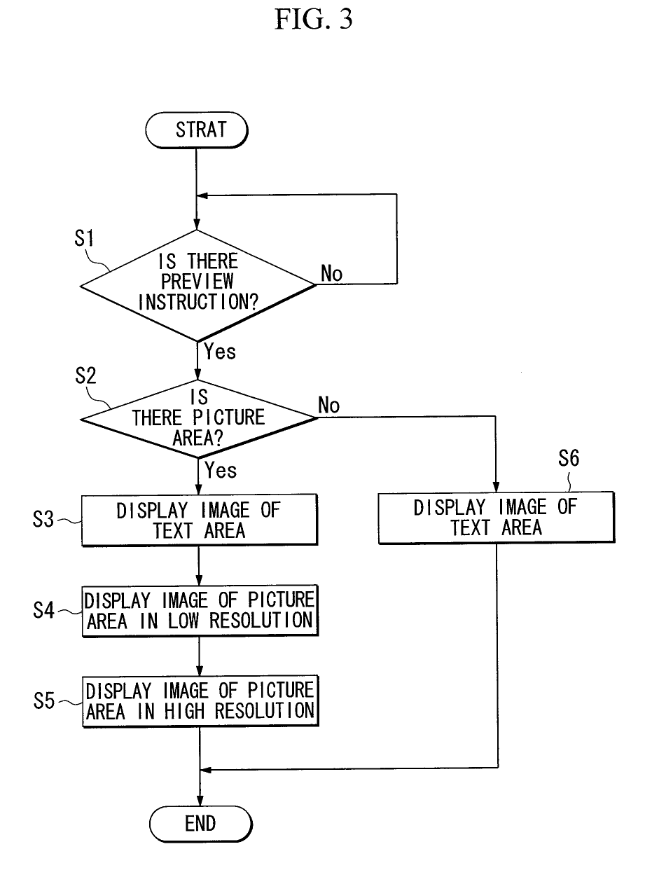

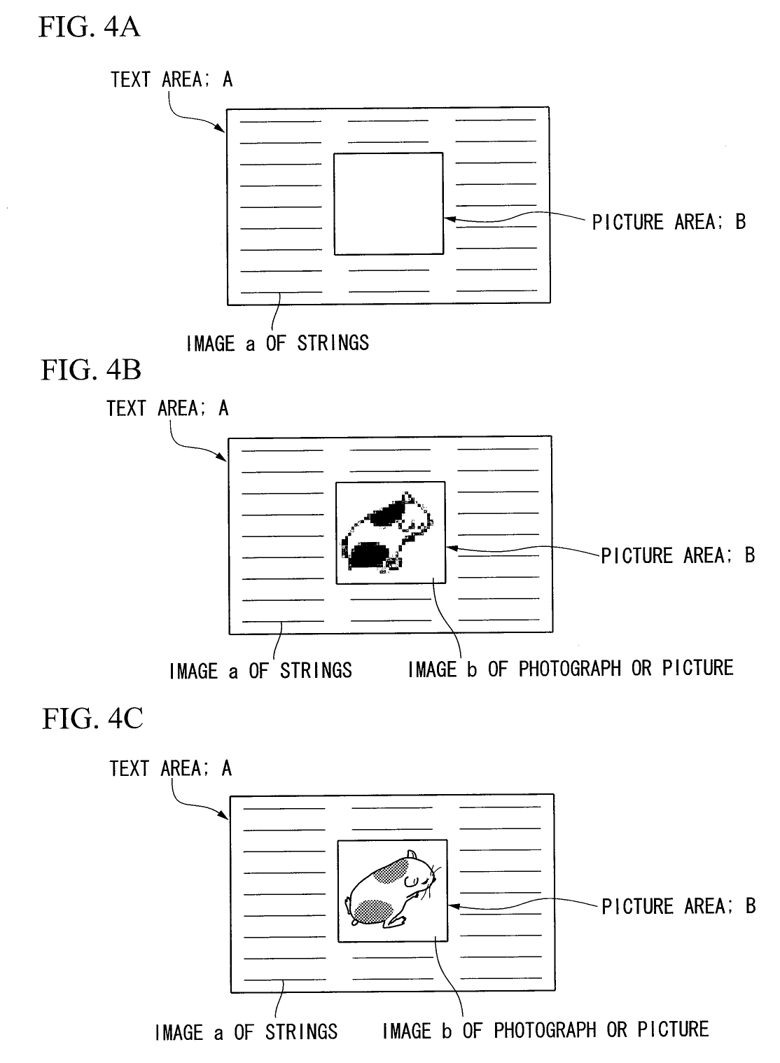

Next, operations of main parts of the multifunctional printer C will be described with reference to a flowchart shown in FIG. 3. FIGS. 4A to 4C are diagrams illustrating display examples of the operation display unit 1 in Steps S3 to S6.

First, the control unit 7 acquires print data from the storage unit 6 or the image processing unit 4, in accordance with an operation instruction of a user to the operation display unit 1. The control unit 7 controls the operation display unit 1 to display names of the print data in a list, and to display a preview button.

When the user selects one from the print data displayed in a list and presses down the preview button, the operation display unit 1 outputs a preview instruction to the control unit 7 (Step S1).

When the preview instruction is input from the operation display unit 1, the control unit 7 analyzes preview image data as described above. By the analysis, it is determined whether or not there is a picture area in a preview image configured on the basis of the preview image data (Step S2).

In Step S2, when it is determined that there is a picture area (Step S2: Yes), the control unit 7 controls the operation display unit 1 firstly to display a preview image of a text area other than the picture area as shown in FIG. 4A (Step S3). Then, the control unit 7 controls the display unit 1 to display a preview image of the picture area in low resolution as shown in FIG. 4B (Step S4). Lastly, the control unit 7 controls the display unit 1 to display the preview image of the picture area in high resolution as shown in FIG. 4C (Step S5), and ends the process.

Processing time of Steps S3 to S5 varies according to the amount of jobs the multifunctional printer C is processing at the time, which can be few seconds or more (e.g., 1 to 2 seconds).

In Step S2, when it is determined that there is no picture area (Step S2: No), the control unit 7 controls the display unit 1 to display a preview image of the text area (i.e., the whole area) (Step S6), and ends the process.

As described above, according to the embodiment, the text area is displayed prior to the picture area, when displaying the preview image.

In displaying the preview image in the multifunctional printer C, an important part for a user, that is, a part to which the user pays attention when determining whether or not the print data is to be printed, is mainly the text area rather then the picture area. In addition, since the text area has a small data size, a long time is not necessary for the display process.

Therefore, according to the present invention, since the important part for a user is promptly displayed when displaying the preview image in the multifunctional printer C, a superior usability for the user can be achieved.

In addition, the processing time for Steps S3 to S5 in the embodiment varies according to the amount of jobs of the multifunctional printer C. When the multifunctional printer C is processing multiple jobs, a processing time of 1 to 2 seconds or longer may be required, in each of Steps S3 to S5.

Thus, in the embodiment, for example, a preview halfway cancel button may be displayed together with the preview image. With such a configuration, a user can interrupt the preview display process to return to the list display screen, by pressing down the preview halfway cancel button.

When the user could verify whether or not the print data is desired data in the step of displaying the text area in Step S3 or in the step of displaying the picture area in low resolution in Step S4, the preview halfway cancel button is particularly useful.

A function such as the preview halfway cancel button may be assigned to a hard key such as a clear key.

In the embodiment, there is employed the stepwise display method of displaying the preview image of the picture area in low resolution and then displaying the preview image of the picture area in high resolution. However, the present invention is not limited thereto. For example, the stepwise display method may be employed only when the intermediate gradation dot number is larger than a predetermined threshold value.

The preview image may be equipped with a page turning function, and/or an enlargement display function.

In the embodiment, the case of displaying the preview image is described as an example. However, the process may also be applied to a thumbnail display process.

Herein, the thumbnail display process is, for example, a process of arranging and displaying, in a small size, only the top page of each of the plurality of print data stored in the storage unit 6. When the user selects one of the thumbnails displayed by the thumbnail display process, a next process such as displaying a preview image of the print data can be performed.

In addition, the embodiment may also be applied to the case of such preview display.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image forming apparatus comprising:
a display unit which displays various kinds of information;
an operation unit which accepts an operation from a user;
a printing unit which prints a printing target image on a recording medium;
a storage unit which stores print data of the printing target image; and
a control unit which integrally controls the display unit, the operation unit, the printing unit, and the storage unit, wherein,
when the operation unit accepts an instruction to display a preview image, the control unit:
generates the preview image from the print data stored in the storage unit, for the user to verify the content of the printing target image;
divides the whole area of the preview image into a text area and a picture area; and
controls the display unit to display an image of the text area, and then to display an image of the picture area.

2. The image forming apparatus according to claim 1, wherein the control unit performs a stepwise display in which a low-resolution image is displayed and then a high-resolution image is displayed, when displaying the image of the picture area.

3. The image forming apparatus according to claim 2, wherein the control unit performs the stepwise display, when a number of intermediate gradation dots in the picture area is greater than a predetermined threshold value.

4. The image forming apparatus according to claim 1, wherein the control unit determines that, in the whole area of the preview image:
a first area is the text area, when the first area includes sub-areas having incontinuous gradations, disposed next to each other; and
a second area is the picture area, when gradations in the second area are continuously changed.

5. The image forming apparatus according to claim 1, wherein the operation unit accepts the instruction to display the preview image, and then accepts an instruction to cancel displaying the preview image, during a displaying process of the preview image.

6. An image processing apparatus comprising:
a display unit which displays various kinds of information;
an operation unit which accepts an operation from a user;
a storage unit which stores target data of a target image; and
a control unit which integrally controls the display unit, the operation unit, and the storage unit, wherein
when the operation unit accepts an instruction to display a preview image, the control unit:
generates a preview image from the target data stored in the storage unit, for the user to verify the content of the target image;
divides the whole area of the preview image into a text area and a picture area; and
controls the display unit to display an image of the text area, and then to display an image of the picture area.

7. An image processing method in which a user verifies the content of a target image, comprising the steps of:
generating a preview image from the target image stored in a storage unit;
dividing the whole area of the preview image into a text area and a picture area;
displaying an image of the text area; and
after displaying the image of the text area, displaying an image of the picture area.
